(19) United States
(12) Patent Application Publication
(10) Pub. No.: US 2007/0064971 A1
(43) Pub. Date: Mar. 22, 2007

(54) Speaker device

(75) Inventor: Yoshimi Kudo, Yamagata (JP)

Correspondence Address: FOLEY AND LARDNER LLP;SUITE 500, 3000 K STREET NW, WASHINGTON, DC, 20007, US

(73) Assignees: PIONEER CORPORATION; Tohoku Pioneer Corporation

(21) Appl. No.: 11/523,788

(22) Filed: Sep. 20, 2006

(30) Foreign Application Priority Data
Sep. 22, 2005 (JP) 2005-276284

(51) Int. Cl. H04R 11/02; H04R 9/06

(52) U.S. Cl. 381/396

(57) ABSTRACT

A speaker device, a voice coil is arranged in a magnetic gap formed in a magnetic circuit unit, a diaphragm that vibrates with a voice coil, and a damper is provided between a diaphragm and a frame and it supports the diaphragm relative to the frame so that the diaphragm can vibrate. Moreover, a damper holder is fixed to the frame and supports the damper, and the magnetic circuit unit is arranged between the damper holder and the frame.

### BACKGROUND OF THE INVENTION

1. Field of the Invention

The present invention generally relates to a speaker device.

2. Description of the Related Art

In a speaker device, a damper is generally provided between a frame and a diaphragm to support the diaphragm relative to the frame so that the diaphragm can vibrate. Moreover, generally, an inner peripheral edge of the damper is connected to a voice coil, and an outer peripheral edge of the damper is fixed to the frame. Due to this, a resonance of the damper and a resonance of the frame conventionally return to the voice coil through the damper. This disadvantageously causes a problem that a delayed and distorted sound is transmitted to the diaphragm, resulting in degradation in sound quality.

To solve the problem, Japanese Patent Application Laid-Open No. 2004-187232 discloses a speaker device in which three or more projections are provided on either a damper holder or a frame, and a point-contact is made between the damper holder and the frame through the projections.

However, in the speaker device disclosed in the Japanese Patent Application Laid-Open No. 2004-187232, an upper portion of a magnetic circuit unit as well as the damper holder attached to the upper portion of the magnetic circuit unit is substantially a free end. Namely, an upper end of the magnetic circuit unit as well as the damper holder is not fixed to the frame, and only a yoke that is a proximal member of the magnetic circuit unit is fixed onto a bottom of the frame. Due to this, if the magnetic circuit unit resonates at a particular frequency of the speaker device, the amplitude of the resonance becomes quite high. In other words, heavy vibrations are generated in the magnetic circuit unit. The vibrations are transmitted to a diaphragm through the damper holder and the damper, disadvantageously resulting in large degradation in sound quality.

### SUMMARY OF THE INVENTION

It is an object of the present invention to at least partially solve the problems in the conventional technology.

According to an aspect of the present invention, a speaker device includes a frame; a magnetic circuit unit that includes a plate, a magnet, and a yoke; a voice coil arranged in a magnetic gap formed in the magnetic circuit unit; a diaphragm that vibrates with the voice coil; a damper that is provided between the diaphragm and the frame, and that supports the diaphragm relative to the frame so that the diaphragm can vibrate; and a damper holder that is fixed to the frame, and that supports the damper. The magnetic circuit unit is arranged between the damper holder and the frame.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a cross section of a speaker device according to an embodiment of the present invention;

FIG. 2 is a rear view of the speaker device shown in FIG. 1;

FIG. 3 is a partially broken side view of a damper holder shown in FIG. 1;

FIG. 4 is a rear view of the damper holder shown in FIG. 3; and

FIG. 5 is a partially enlarged cross section of the damper holder shown in FIG. 3.

### DETAILED DESCRIPTION OF THE PREFERRED EMBODIMENTS

Exemplary embodiments of the present invention will be explained hereinafter in detail with reference to the accompanying drawings.

A speaker device according to an embodiment of the present invention includes: a frame; a magnetic circuit unit that includes a plate, a magnet, and a yoke; a voice coil arranged in a magnetic gap formed in the magnetic circuit unit; a diaphragm that vibrates with the voice coil; a damper that is provided between the diaphragm and the frame, and that supports the diaphragm relative to the frame so that the diaphragm can vibrate; and a damper holder that supports an outer peripheral edge of the damper from a direction of the frame. The damper holder is fixed to the frame, and fixes the outer peripheral edge of the damper. Axial both ends of the magnetic circuit unit are arranged between the damper holder and the frame.

As a result, the magnetic circuit unit can be firmly fixed to the frame, and therefore, the speaker device according to the embodiment can suppress vibration of the magnetic circuit unit and enhance sound quality.

The damper holder includes a first member fixable to the plate of the magnetic circuit unit; and a second member fixable to the frame.

The damper holder is firmly fixed to the plate of the magnetic circuit unit and firmly fixed to the frame. Therefore, by fixing the magnetic circuit unit to the frame more firmly, the speaker device can further suppress the vibration of the magnetic circuit unit and further enhance the sound quality.

The yoke that constitutes the magnetic circuit unit is fixed to the frame.

The yoke that is a proximal member of the magnetic circuit unit is fixed to the frame more firmly. Therefore, the speaker device can further suppress the vibration of the magnetic circuit unit and further enhance the sound quality.

The damper holder includes a first annular member fixable to the magnetic circuit unit; an annular damper-support member provided coaxially with the first annular member, and having a larger diameter than a diameter of the first annular member; and a plurality of arms provided circumferentially at predetermined intervals, the plurality of arms connecting the first annular member to the annular damper-support member.

The first annular member and the damper-support member are connected to each other by the arms. Namely, other than the arms, there is no material, that is, there is empty space, between the first annular member and the damper-support member in the damper holder. It is thereby possible to make the speaker device light in weight.

Each of the second members is provided in each of the arms.

The reason for this is that the second members are unnecessary to be provided over an entire periphery of the damper holder, differently from the first member and the damper-support member. It is thereby possible to make the speaker device light in weight and compact in size.

A clearance is secured between the frame and a portion of the damper holder outward of the second members reaching the annular damper-support member so as to prevent contact between the portion of the damper holder and the frame.

The contact portions between the damper holder and the frame are minimized, and the clearance is secured between the damper holder and the frame particularly on the damper-support member side in a direction of an outside diameter of the damper holder. It is thereby possible to suppress the resonance of the damper holder and that of the frame from being transmitted to the damper and returning to the voice coil, and therefore to prevent degradation in sound quality.

The number of fixing members that fix the frame to respective speaker attachment positions differs from the number of the second members.

Namely, an eigenfrequency of the damper holder is set different from that of the frame, which makes it difficult for the damper and the frame to resonate. Therefore, the speaker device can enhance the sound quality.

An adhesive relief groove is provided in a surface of the first member, the surface of the first member opposing the plate.

An excessive amount of the adhesive is relieved to the adhesive relief groove, so that the damper holder can be bonded to the plate while the surface of the first member is closely attached to a principal surface of the plate. It is thereby possible to fix the magnetic circuit unit to the frame further firmly. The speaker device can, therefore, further suppress the vibration of the magnetic circuit unit and further enhance the sound quality.

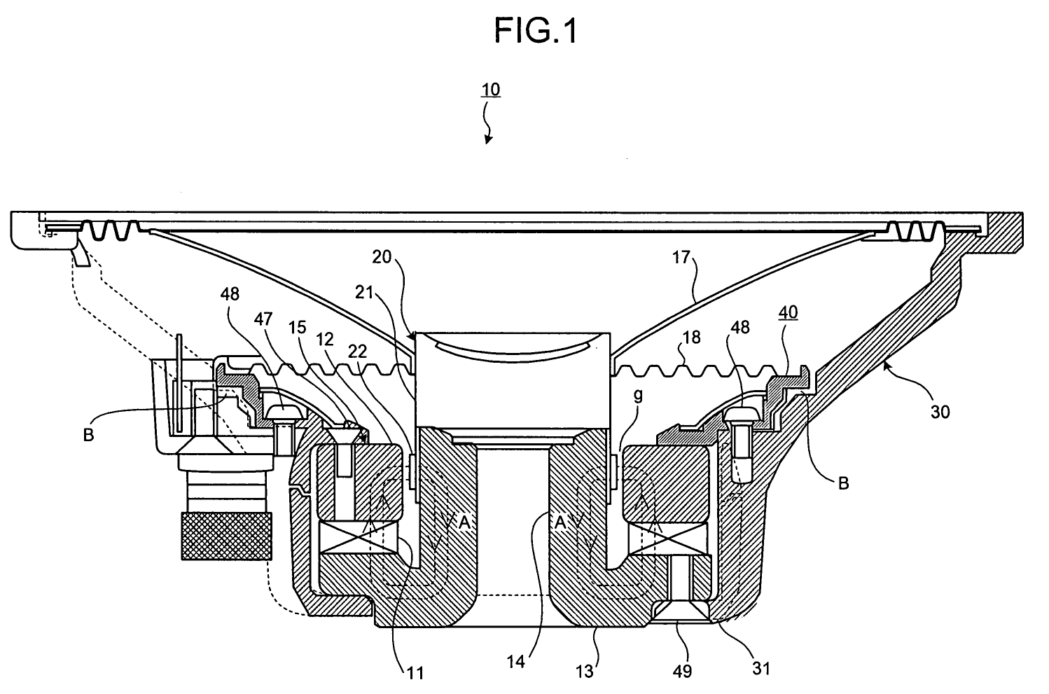

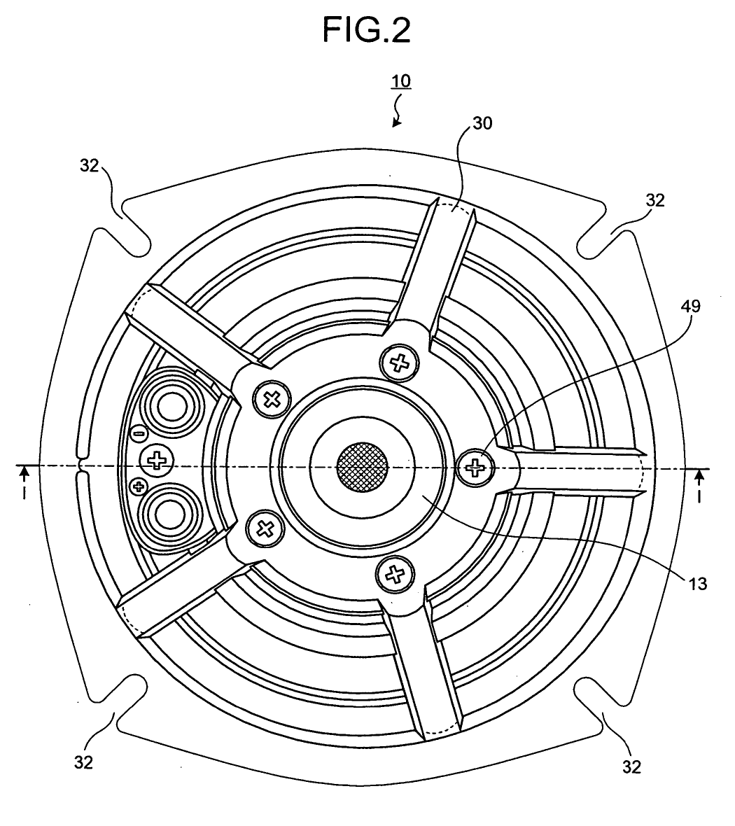

FIG. 1 is a cross section of a speaker device 10 according to the embodiment of the present invention. FIG. 2 is a rear view of the speaker device 10 shown in FIG. 1. FIG. 2 depicts the speaker device from an opposite direction to a direction of sound radiation of the speaker device 10. FIG. 1 is the cross section taken along a line I-I of FIG. 2. Referring to FIGS. 1 and 2, the speaker device 10 includes a vibration system and a magnetic circuit system. The vibration system includes a conical diaphragm (hereinafter, “diaphragm”) 17 and a voice coil 20. The magnetic circuit system includes a yoke 13, a center pole 14, a magnet 11, and a top plate (hereinafter “plate”) 12. The magnetic circuit system constitutes a magnetic circuit unit 15. The voice coil 20 includes a bobbin 21 and a wire 22. A generally truncated-conical frame 30 is provided to cover up an outermost periphery of the speaker device 10. The vibration system and the magnetic circuit system are housed in the frame 30. As the magnet 11, either a magnet excited by a DC power supply or a permanent magnet can be used.

The plate 12 that is thin ring-shaped and made of a magnetic material such as iron is superimposed on a front surface of the magnet 11 that is thin ring-shaped. The yoke 13 that is generally disk-shaped and made of a magnetic material such as iron similarly to the plate 12 is provided on a back surface of the magnet 11. The center pole 14 that is hollow-cylindrical and integrated with the yoke 13 is provided in a central portion of a front surface of the yoke 13. A magnetic gap g is formed between an outer circumferential surface of the center pole 14 and an inner peripheral surface of the plate 12. A generally annular damper holder 40 is provided forward of the plate 12 (in the direction of the sound radiation of the speaker device 10).

The generally trumpet-shaped diaphragm 17 is provided forward of the center pole 14 with a large-diameter part of the diaphragm 17 directed forward. The generally cylindrical voice coil 20 is connected to a central hole of the diaphragm 17 with a central axis of the voice coil 20 made coincident with that of the diaphragm 17. The voice coil 20 is supported by the damper holder 40 through an elastic damper 18 so that the voice coil 20 can axially move forward and backward. A circumferential edge of the large-diameter part of the diaphragm 17 is fixed to an outer peripheral edge of the frame 30. In addition, a circumferential edge of a small-diameter part of the diaphragm 17 is connected to and supported by the voice coil 20. The wire 22 is wound around an outer circumferential surface of the bobbin 21 of the voice coil 20, and the voice coil 20 is arranged so that the wire 22 is located at a predetermined position in the magnetic gap g.

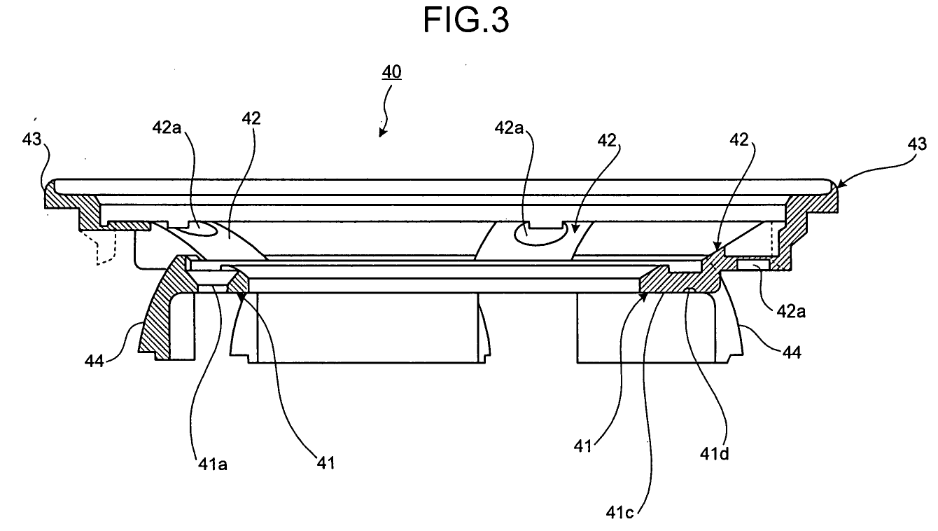

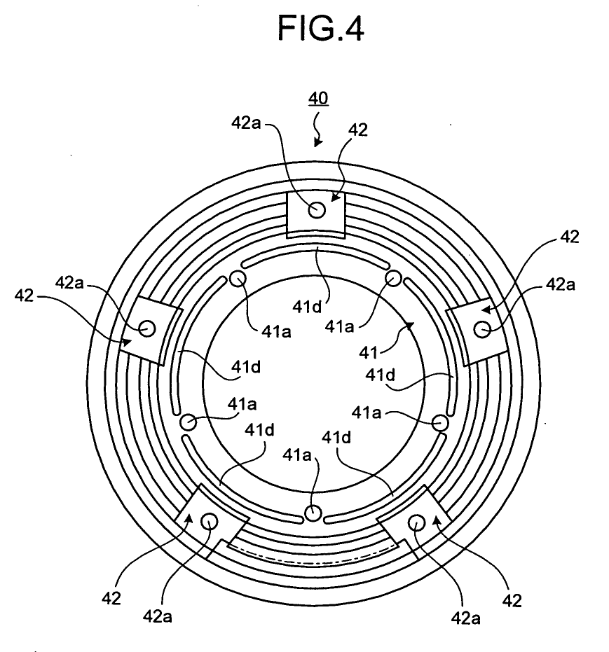

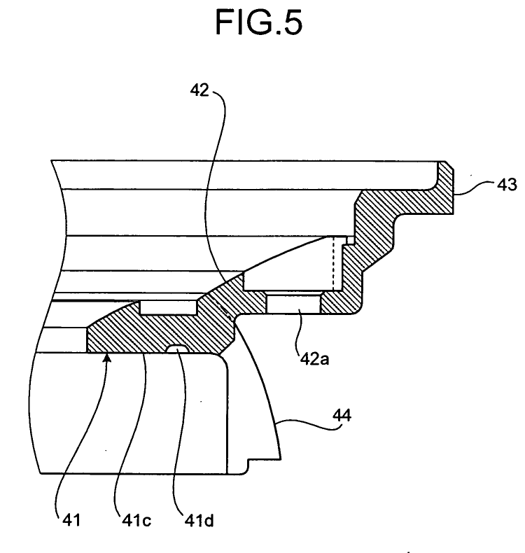

FIG. 3 is a partially broken side view of the damper holder 40. FIG. 4 is a rear view of the damper holder 40 shown in FIG. 3. FIG. 4 depicts the damper holder 40 from a direction of the plate 12. FIG. 5 is a partial enlarged cross section of the damper holder 40. The damper holder 40 includes a generally annular first member 41, a plurality of (five in the embodiment) arms (second members) 42, a plurality of generally annular damper-support members 43, and a skirt 44. The arms 42 are provided circumferentially and equidistantly on an outer peripheral edge of the first member 41 to extend radially. The damper-support members 43 are connected to tip ends of the respective arms 42 and provided coaxially with the first member 41. The skirt 44 extends downward from a portion of the outer peripheral edge of the first member 41, in which portion the arms 42 are not provided, to cover up the magnetic circuit unit 15.

Screw holes 41a are circumferentially formed in a plurality of portions (five portions corresponding to the five arms 42 in the embodiment) of the first member 41 located at an inner position of the damper holder 40. In addition, a circular-arc-shaped adhesive relief groove 41d is provided between adjacent screw holes 41a on a surface 41c of the first member 41. The surface 41c of the first member 41 opposes (is closely attached to) the plate 12. Screw holes 42a are formed in the respective five arms 42 located at intermediate positions of the damper holder 40.

Referring back to FIG. 1, the yoke 13, the magnet 11, and the plate 12 that constitute an outer periphery side of the magnetic circuit unit 15 are integrally and fixedly bonded to one another by adhesive applied onto principal surfaces of the yoke 13, the magnet 11, and the plate 12, respectively. The magnetic circuit unit 15 is structured to be put between the damper holder 40 and a bottom 31 of the frame 30. The damper holder 40 is secured to the plate 12 by fixing screws 47 each of which penetrates each of the screw holes 41a formed in the first member 41. In addition, the damper holder 40 is bonded to the plate 12 by the adhesive impregnated between the surface 41c of the first member 41 and the principal surface of the plate 12. The damper holder 40 is thereby firmly fixed to the plate 12. The damper holder 40 is also firmly fixed to the frame 30 by fixing screws 48 each of which penetrates each of the screw holes 42a formed in the respective five arms 42. Moreover, the yoke 13 that serves as the proximal member of the magnetic circuit unit 15 is firmly fixed to the frame 30 by fixing screws 49 each of which penetrates each of screw holes formed in the bottom 31 of the frame 30. Furthermore, a clearance B is secured between the frame 30 and a portion of the damper holder 40 outward of the arms 42 reaching the damper-support member 43 so as to prevent contact between the portion of the damper holder 40 and the frame 30. An outer peripheral edge of the damper 18 is fixed to the damper-support members 43.

An operation performed by the speaker device 10 according to the embodiment will now be explained. The magnetic circuit unit 15 that includes the yoke 13, the center pole 14, the magnet 11, and the plate 12 forms a magnetic flux A shown in FIG. 1. The magnetic flux A generates a uniform magnetic field in the magnetic gap g in a direction orthogonal to an axial direction of the speaker device 10. The wire 22 is arranged in the magnetic gap g and located in the magnetic field generated by the magnetic flux A. Therefore, if a voice current is applied to the wire 22, an amplitude-vibration is generated in the axial direction by an electromagnetic effect between the voice current and the magnetic field. The amplitude-vibration is transmitted to the diaphragm 17, and the diaphragm 17 vibrates, accordingly. As a result, sound is radiated from the speaker device 10.

In the speaker device 10, the magnetic circuit unit 15 is firmly fixed to the frame 30, i.e., firmly put between the damper holder 40 and the frame 30. It is thereby possible to suppress the vibration of the magnetic circuit unit 15 and enhance the sound quality. Furthermore, the damper holder 40 is firmly fixed to the plate 12 and firmly fixed to the frame 30. The yoke 13 is firmly fixed to the frame 30. Therefore, the magnetic circuit unit 15 is fixed to the frame 30, i.e., put between the damper holder 40 and the frame 30, more firmly. It is thereby possible to further suppress the vibration of the magnetic circuit unit 15 and further enhance the sound quality.

In the damper holder 40, there is empty space between the first annular member and the damper-support member other than the arms. It is thereby possible to make the speaker device 10 light in weight. Because the second members are unnecessary to be provided over an entire periphery of the damper holder 40, differently from the first member 41 and the damper-support member 43, each of the second members is provided in the respective arms 42. It is thereby possible to make the speaker device 10 light in weight and compact in size.

Furthermore, due to the presence of the clearance B, the contact portions between the damper holder 40 and the frame 30 are minimized. In addition, it is possible to suppress the resonance of the damper holder 40 and that of the frame 30 from being transmitted to the damper 18 and returning to the voice coil 20, and therefore to prevent degradation in sound quality.

Due to the presence of the adhesive relief groove 41d, an excessive amount of the adhesive is relieved to the adhesive relief groove 41d, as a result, the damper holder 40 can be bonded to the plate 12 while the surface 41c of the first member 41 is closely attached to the principal surface of the plate 12. It is thereby possible to fix the magnetic circuit unit 15 to the frame 30 further firmly. The speaker device 10 can, therefore, further suppress the vibration of the magnetic circuit unit 15 and further enhance the sound quality.

As shown in FIG. 2, four screw-insertion notches 32 serving as fixing members are provided on an outer circumferential edge of the frame 30 to fix the speaker device 10 to, for example, respective enclosure speaker attachment positions. In this manner, the four fixing members (screw-insertion notches 32) are provided for fixing the frame 30 to the respective speaker attachment positions, while the five fixing members (screw holes 42a) are provided for fixing the damper holder 40 to the frame 30. The reason for this is to intend to enhance the sound quality by making it difficult for the damper holder 40 and the frame 30 to resonate.

The speaker device 10 according to the embodiment of the present invention is not limited to the example described above, and various changes and modifications can be made of the present invention. For example, in the above example, the conical speaker device 10 has been explained. However, the present invention is similarly applicable to a dome-shaped speaker device.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A speaker device comprising:
a frame;
a magnetic circuit unit that includes a plate, a magnet, and a yoke;
a voice coil arranged in a magnetic gap formed in the magnetic circuit unit;
a diaphragm that vibrates with the voice coil;
a damper that is provided between the diaphragm and the frame, and that supports the diaphragm relative to the frame so that the diaphragm can vibrate; and
a damper holder that is fixed to the frame, and that supports the damper, wherein
the magnetic circuit unit is arranged between the damper holder and the frame.

2. The speaker device according to claim 1, wherein the damper holder includes
a first member fixable to the plate of the magnetic circuit unit; and
a second member fixable to the frame.

3. The speaker device according to claim 1, wherein the yoke is fixed to the frame.

4. The speaker device according to claim 1, wherein the damper holder includes
a first annular member fixable to the magnetic circuit unit;
an annular damper-support member provided coaxially with the first annular member, and having a larger diameter than a diameter of the first annular member; and
a plurality of arms provided circumferentially at predetermined intervals, the plurality of arms connecting the first annular member to the annular damper-support member.

5. The speaker device according to claim 2, wherein the damper holder includes
a first annular member fixable to the magnetic circuit unit;
an annular damper-support member provided coaxially with the first annular member, and having a larger diameter than a diameter of the first annular member; and
a plurality of arms provided circumferentially at predetermined intervals, the plurality of arms connecting the first annular member to the annular damper-support member.

6. The speaker device according to claim 5, wherein each of the second members is provided on each of the arms.

7. The speaker device according to claim 5, wherein a clearance is secured between the frame and a portion of the damper holder outward of the second members reaching the annular damper-support member to prevent contact between the portion of the damper holder and the frame.

8. The speaker device according to claim 2, wherein number of fixing members that fix the frame to respective speaker attachment positions differs from number of the second members.

9. The speaker device according to claim 2, wherein an adhesive relief groove is provided on a surface of the first member, the surface of the first member opposing the plate.

10. The speaker device according to claim 1, wherein the magnetic circuit unit makes physical contact with the damper holder and the frame.
